(19) United States
(12) Patent Application Publication
(10) Pub. No.: US 2026/0361686 A1
(43) Pub. Date: Nov. 12, 2026

(54) Method for Broadcasting Communications in Multiple Languages in a Group Communication System

(71) Applicant: MOTOROLA SOLUTIONS, INC., Chicago, IL (US)

(72) Inventors: Madhusudan PAI, Frisco, TX (US); Rajendra ANTHONY, Richardson, TX (US)

(21) Appl. No.: 19/202,195

(22) Filed: May 8, 2025

(51) Int. Cl. H04L 61/5069; H04L 51/222; H04W 4/021

(52) U.S. Cl. CPC H04L 61/5069; H04L 51/222; H04W 4/021

(57) ABSTRACT

A process for broadcasting communications in multiple languages in a group communication system includes a communication server identifying communication devices affiliated with a communication group and registering language preferences indicating desired languages for receiving group communications for each device. The server determines a sub-group of devices located in a broadcast area and analyzes their registered preferences to determine a set of languages for broadcasting in that area. The server coordinates with broadcast stations serving the broadcast area to broadcast the communications in the determined set of languages to the first broadcast area. The server optimizes resource utilization by broadcasting only required language versions to each broadcast area.

### BACKGROUND

Group communication systems are widely deployed in public safety and enterprise environments to enable coordinated communications between multiple users and devices across different geographical areas. Group communication systems utilize various broadcast technologies to deliver content efficiently to groups of users distributed across different service areas. As communication networks evolve, broadcast delivery mechanisms provide ways to deliver group communications to multiple users simultaneously across diverse geographical regions.

### BRIEF DESCRIPTION OF THE SEVERAL VIEWS OF THE DRAWINGS

In the accompanying figures similar or the same reference numerals may be repeated to indicate corresponding or analogous elements. These figures, together with the detailed description, below are incorporated in and form part of the specification and serve to further illustrate various embodiments of concepts that include the claimed invention, and to explain various principles and advantages of those embodiments.

FIG. 1 is a block diagram of a group communication system in accordance with some embodiments.

FIG. 2 is a block diagram of a communication device shown in FIG. 1 in accordance with some embodiments.

FIG. 3 is a block diagram of a push-to-X (PTX) communication server shown in FIG. 1 in accordance with some embodiments.

FIG. 4 is a flowchart of a method for broadcasting communications in multiple languages in accordance with some embodiments.

FIG. 5 illustrates broadcast channel allocation across multiple broadcast areas in accordance with some embodiments.

FIG. 6 shows a message flow diagram illustrating messages sent from a PTX communication server to communication devices in different broadcast areas using separate TMGIs for each language.

FIG. 7 shows another message flow diagram illustrating messages sent from a PTX communication server to communication devices in different broadcast areas using a single TMGI for multiple languages.

FIG. 8 shows a user interface to switch between different languages for receiving group communications being broadcast in a current broadcast area of a user.

Skilled artisans will appreciate that elements in the figures are illustrated for simplicity and clarity and have not necessarily been drawn to scale. For example, the dimensions of some of the elements in the figures may be exaggerated relative to other elements to help improve understanding of embodiments of the present disclosure.

The apparatus and method components have been represented where appropriate by conventional symbols in the drawings, showing only those specific details that are pertinent to understanding the embodiments of the present disclosure so as not to obscure the disclosure with details that will be readily apparent to those of ordinary skill in the art having the benefit of the description herein.

### DETAILED DESCRIPTION OF THE INVENTION

Group communication systems including mission critical push-to-talk (MCPTT) communication systems face challenges in efficiently managing and delivering content across diverse user populations, particularly when coordinating communications across different geographical regions while managing limited network resources and bandwidth constraints. Broadcasting group communications becomes particularly complex when the same content needs to be delivered multiple times to accommodate different user requirements within the same broadcast area. For example, broadcast delivery mechanisms like evolved Multimedia Broadcast Multicast Service (eMBMS) in 4G networks and Multicast-Broadcast Service (MBS) in 5G networks enable broadcast delivery of group communications, but face fundamental limitations when managing translated group communications across diverse user populations.

When group communications need to be translated to multiple languages, conventional broadcast approaches result in inefficient resource utilization as the same translated content must be transmitted multiple times to accommodate different language requirements. This challenge becomes particularly acute in mission critical scenarios, such as emergency response operations where teams speaking different languages need to coordinate across multiple geographical areas. The inefficient use of broadcast resources is further compounded when managing translations across multiple service areas, as current systems lack effective mechanisms to optimize resource allocation based on the actual language requirements of users in each area. In time-sensitive situations, the need to broadcast critical instructions or status updates in multiple languages can strain network resources, especially when teams move between different broadcast areas while still requiring access to communications in their preferred languages.

These technical limitations impact operational effectiveness, especially in scenarios requiring immediate and clear communication across language barriers. The challenge of efficient resource allocation becomes more pronounced as these systems scale to serve larger user populations across expanding geographical regions. Accordingly, there is a need for technological solutions that can optimize broadcast resource utilization by intelligently managing the delivery of translated content across multiple service areas based on the actual language requirements of users in each area.

Embodiments described below provides an improved technical solution for optimizing broadcast resource utilization by determining a set of translated languages needed in each broadcast area based on the language preferences of group members affiliated to that area. When a group communication needs to be delivered, a communication server first analyzes the affiliated group members’ language preferences to determine which translated versions are actually required in each broadcast area. Rather than broadcasting all language versions everywhere, the communication server selectively transmits only the necessary translated streams to each respective broadcast area. For example, if a first broadcast area includes only users requiring English and Spanish translations, then the system broadcasts translated communications only in English and Spanish in the first broadcast area. If a second broadcast area includes only users requiring French translations, then the system broadcasts translated communications only in French in the second broadcast area. This targeted delivery approach prevents wasteful transmission of unused translations. The system also enables dynamic adjustment of resource allocation by tracking user language preferences and group affiliations across different broadcast areas. When users move between areas or change their language preferences, the system can update which translated versions are broadcast in the affected areas. Additionally, the solution provides a user interface to allow users to switch between available translated versions within their broadcast area while maintaining efficient resource utilization through coordinated delivery mechanisms. This intelligent management of translated content delivery helps optimize bandwidth usage and network capacity across the communication system.

One embodiment provides a method for broadcasting communications in multiple languages in a group communication system. The method comprises: identifying, at a communication server, a plurality of communication devices affiliated with a communication group; registering, at the communication server, a language preference for each of the communication devices in the plurality of communication devices affiliated with the communication group, wherein the language preference indicates a desired language for receiving group communications; identifying, at the communication server, a first sub-group of communication devices currently located in a first broadcast area; determining, at the communication server, a first set of languages to be used for broadcasting the group communications in the first broadcast area based on the language preferences of the sub-group of communication devices located in the first broadcast area; and broadcasting, at the communication server, via one or more broadcast stations serving the first broadcast area, the group communications in the first set of languages to the first broadcast area.

Another embodiment provides a communication server comprising a memory and an electronic processor communicatively coupled to the memory. The memory is configured to store language preference information for a plurality of communication devices affiliated with a communication group. The language preference indicates a desired language for receiving group communications. The electronic processor is configured to: identify a first sub-group of communication devices currently located in a first broadcast area; determine a first set of languages to be used for broadcasting group communications in the first broadcast area based on the language preferences of the first sub-group of communication devices; and broadcast the group communications in the first set of languages to the first broadcast area via one or more broadcast stations serving the first broadcast area.

Each of the above-mentioned embodiments will be discussed in more detail below, starting with example system and device architectures of the system in which the embodiments may be practiced, followed by an illustration of processing blocks for achieving an improved technical method, device, and system for broadcasting communications in multiple languages in a group communication system. Example embodiments are herein described with reference to flowchart illustrations and/or block diagrams of methods, apparatus (systems) and computer program products according to example embodiments. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. The methods and processes set forth herein need not, in some embodiments, be performed in the exact sequence as shown and likewise various blocks may be performed in parallel rather than in sequence. Accordingly, the elements of methods and processes are referred to herein as “blocks” rather than “steps.”

These computer program instructions may also be stored in a computer-readable memory that can direct a computer or other programmable data processing apparatus to function in a particular manner, such that the instructions stored in the computer-readable memory produce an article of manufacture including instructions which implement the function/act specified in the flowchart and/or block diagram block or blocks.

The computer program instructions may also be loaded onto a computer or other programmable data processing apparatus to cause a series of operational blocks to be performed on the computer or other programmable apparatus to produce a computer implemented process such that the instructions which execute on the computer or other programmable apparatus provide blocks for implementing the functions/acts specified in the flowchart and/or block diagram block or blocks. It is contemplated that any part of any aspect or embodiment discussed in this specification can be implemented or combined with any part of any other aspect or embodiment discussed in this specification.

Further advantages and features consistent with this disclosure will be set forth in the following detailed description, with reference to the figures.

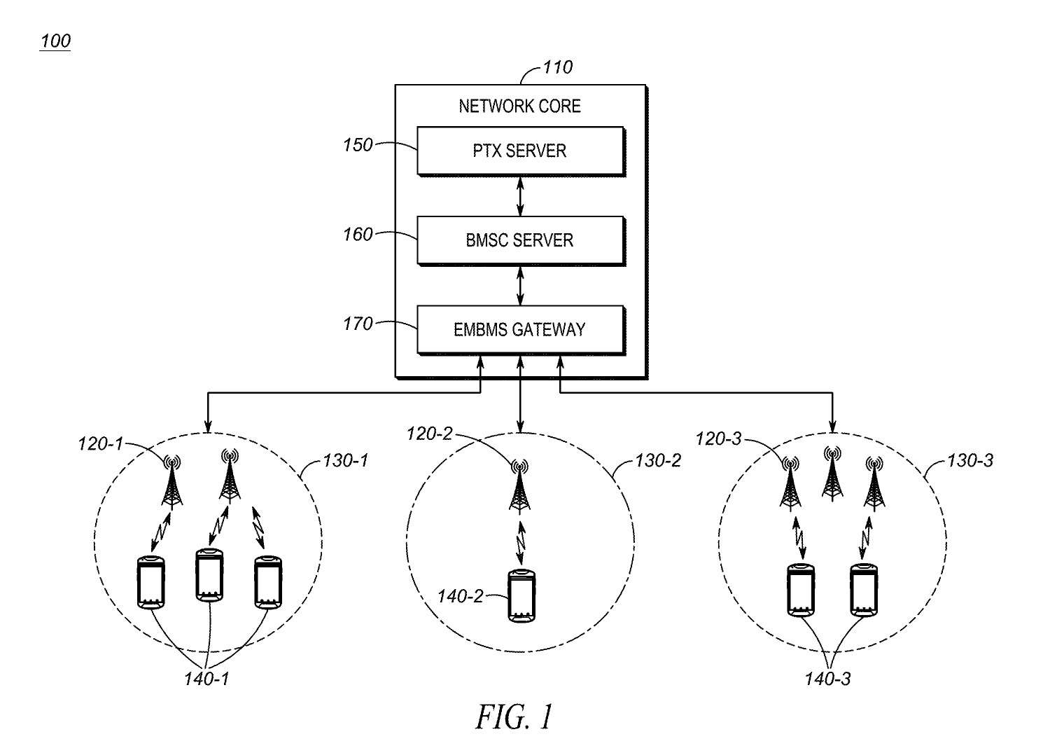

Referring now to the drawings, and in particular FIG. 1, a group communication system 100 includes a network core 110 that provides infrastructure for managing group communications across multiple broadcast areas. The group communication system 100 enables delivery of group communications in multiple languages by translating communications between source and target languages based on language preferences. As used herein, a source language refers to the original language of transmitted communications, while target languages refer to the languages into which the communications are translated for delivery. The network core 110 is connected to multiple broadcast stations 120 that may be implemented as one or more of base stations, Evolved Node Bs (eNodeBs) (in long term evolution (LTE) technology), next generation Node Bs or gNodeBs (in 5G technology) or any other device or infrastructure implemented with broadcast technologies that are suitable for broadcasting group communications received from the network core 110. Each broadcast station 120 includes hardware and software components for communicating wirelessly with different network components included in the group communication system 100. For example, in some embodiments, the network core 110 controls the broadcast station 120 to broadcast communications in a broadcast area 130 served by the broadcast station 120.

The system 100 shown in FIG. 1 includes multiple broadcast areas 130-1, 130-2, and 130-3. As used herein, a broadcast area refers to a geographic region served by one or more broadcast stations 120 where broadcast services are provided to communication devices 140. Each broadcast area 130 supports delivery of group communications in different languages based on language preferences, where a language preference refers to a user-selected or system-configured setting that determines which language a communication device 140 prefers to receive communications. For example, in broadcast area 130-1, the system 100 may support delivery of communications in English and Spanish based on users preferring English and Spanish, while broadcast area 130-2 may support delivery of communications in French for users preferring that language. In Third Generation Partnership Project (3GPP) networks, the broadcast areas 130 are implemented as service area identifiers (SAIs), where each SAI represents a defined coverage region for delivering broadcast content. The broadcast areas 130 may be implemented using various wireless technologies including 4G Long Term Evolution (LTE) enhanced Multimedia Broadcast Multicast Services (eMBMS) or 5G Media Broadcast Multicast Service (MBS) to enable delivery of group communications to multiple communication devices 140 simultaneously. Each broadcast area 130 represents a service coverage region that can span any number of broadcast stations 120. While three broadcast areas 130-1, 130-2, and 130-3 are shown in FIG. 1, the system 100 may include additional broadcast areas 130 served by additional broadcast stations 120.

The communication system 100 implements multilingual group communications through efficient broadcast delivery mechanisms. As used herein, group communications refer to any form of communication including voice, text, video, or multimedia content exchanged between members of a defined talkgroup. To enable delivery of translated content across broadcast areas 130, the system 100 utilizes unique identifiers for managing broadcast streams. A Temporary Mobile Group Identifier (TMGI) is a unique identifier allocated within a broadcast area 130 or SAI for delivering broadcast content to multiple users simultaneously through broadcast bearers. As used herein, a broadcast bearer refers to a communication channel established between network components for delivering group content to multiple devices simultaneously within a broadcast area. As used herein, a language stream refers to a continuous flow of translated communications in a specific language delivered through a designated TMGI or internet protocol address/port combination. For example, in broadcast area 130-1 (SAI-1), TMGI-11 may be used for English broadcasts while TMGI-12 is used for Spanish broadcasts.

The communication devices 140 may include, but are not limited to, two-way radios (e.g., land mobile radio or LMR), a battery-powered radio speaker microphone (RSM) video capture device, mobile phones, cellular phones, smart phones, vehicular radios, laptop computers, and tablets. The communication devices 140 may be carried or worn by users such as public safety responders including police officers, firefighters, paramedics, and emergency medical technicians, as well as enterprise users including security personnel, construction workers, logistics staff, retail employees, and hotel staff, all generically referred to as user(s), member(s), or participant(s) of a talkgroup. User applications (also referred to as “clients”) reside on communication device 140 for accessing various communication services including translation services provided by the system 100. An example of a user application is a client-side push-to-talk (PTT) call application that provides instantaneous private and group communication at the push of a software interface or a hardware interface implemented at the communication device 140.

The communication devices 140 operate in a group communications mode, where devices 140 affiliated with the same talkgroup can participate in group calls and exchange group communications. The group communications infrastructure allows a single communication device 140 (also referred to as a “transmitting communication device 140”) to communicate with one or more other devices (also referred to as “receiving communication device 140”) associated with a particular talkgroup at the same time. The communication device 140 or a user operating the communication device 140 may be referred herein as a “member” or “participant” of one or more talkgroups. While the term “talkgroup” is used, terms like “communication group,” “call group,” or “PTT group” could be used interchangeably, and the communications exchanged during group calls may include text, audio, image, video, and other media types. Further, the term “talkgroup” is used in this disclosure to refer to a particular group of communication devices 140 that operate on a common communication channel (e.g., LMR transmission or reception channel frequency) specifically assigned to the talkgroup to participate in a group call associated with the talkgroup. Devices 140 affiliated with the same talkgroup may be deployed for operation in the same broadcast area, such as when users are assigned to respond to the same incident or task, or may be distributed across multiple broadcast areas 130. In one embodiment, the communication device 140 may be participating in a one-on-one communication session involving only a single transmitting communication device 140 and a single receiving communication device 140.

Each communication device 140 is normally maintained in a monitor only mode, and switches to transmit-only mode (half-duplex) or transmit and receive mode (full-duplex) upon activation of a push-to-talk input. When push-to-talk input (e.g., a PTT key or button, or a soft PTT input via touch interface) is activated (e.g,, when pressed and held), the communication device 140 transmits a floor request to a PTX communication server 150 (also referred herein as a “communication server” or a “PTX server”). Upon floor grant by the PTX communication server 150, the communication device 140 can transmit communications to other talkgroup members. When the PTT button is released, the communication device 140 sends a floor release indication. During PTT key-up operation, other devices can receive but cannot transmit until the floor is released and granted to another device.

The communication devices 140 in the system 100 are distributed across different broadcast areas 130. For example, devices 140-1 are shown as operating within broadcast area 130-1 (referred to as a “first broadcast area”), devices 140-2 within broadcast area 130-2 (referred to as a “second broadcast area”), and devices 140-3 within broadcast area 130-3 (referred to as a “third broadcast area”). In one embodiment (also referred to as a “multi-TMGI embodiment”), when a PTT call is established, each communication device 140 receives an enhanced broadcast configuration message. As used herein, in the multi-TMGI embodiment, an enhanced broadcast configuration message refers to a control message sent to communication devices 140 that contains a list of TMGIs available in their broadcast area 130 and the associated language for each TMGI. Based on the language preference, the communication device 140 determines which TMGI to monitor and processes the corresponding media stream in that language. The user interface at the communication device 140 enables options to switch language to any available translated content (including text, audio, image, video, and other media types) in that broadcast area by switching to the appropriate TMGI. In another embodiment (also referred to as a “single TMGI embodiment”), each communication device 140 receives an enhanced broadcast configuration message containing a single TMGI for their broadcast area along with a list of internet protocol (IP) addresses and ports, each associated with a different language stream. The communication device 140 is configured to determine the appropriate IP/port combination based on the user’s language preference and processes the corresponding media stream. The device’s user interface also enables options to switch to other available languages for any supported media type by selecting a different IP/port combination on the same TMGI.

In the example illustrated, the network core 110 includes network components including a push-to-X (PTX) communication server 150 (also referred herein as “a communication server), a broadcast multicast service center (BMSC) server 160, and an enhanced multimedia broadcast multicast services (eMBMS) gateway 170 that manage different aspects of a 4G LTE group communication system 100.

The PTX communication server 150 exchanges PTX control signals (e.g., group call requests) and data (e.g., voice, video, image, text, or combination thereof) with the communication devices 140. The PTX communication server 150 provides translation services during PTT calls by translating group communications from a source language to one or more target languages before broadcast delivery via the broadcast stations 120. When the source language of group communications differs from the language preferences registered for communication devices 140 in a talkgroup, the PTX communication server 150 employs one or more translations engines that utilizes machine translation algorithms and linguistic data to automatically convert the communications (e.g., text, audio, image, video, or combination thereof) from the source language to target language in real-time. Prior to broadcasting group communications in different languages using the allocated TMGIs, the PTX communication server 150 determines whether the target languages are different from the source language used in the initial transmission. When the target languages differ from the source language, the PTX communication server 150 provides translation of the group communications from the source language to each required target language before the BMSC server 160 broadcasts the communications. For example, if a Spanish-speaking member of a talkgroup transmits communications that need to be delivered to both English and French language recipients of the same talkgroup but located in different broadcast areas, the PTX communication server 150 first translates the Spanish source content into the required target languages i.e., English and French, before broadcasting the translated communications through the appropriate TMGIs or IP/port combinations.

The PTX communication server 150 may be implemented as a radio controller, push-to-talk (PTT) server, zone controller, mobile management entity (MME), base station controller (BSC), mobile switching center, site controller, call controller, or other network device. While the PTX communication server 150 is illustrated as a separate entity in the system 100, the PTX communication server 150 may be integrated with other devices (such as a zone controller) in a communication network (e.g., within a broadcast station 120 or infrastructure radio access network). The PTX communication server 150 is configured to provide registration, translation, authentication, encryption, routing, and/or other services to communication devices 140 operating within broadcast areas 130 served by broadcast stations 120. In accordance with some embodiments, the PTX communication server 150 controls allocations of communication resources (e.g., broadband broadcast bearers, land mobile radio frequency channels etc.,) required to establish group calls between communication device 140 affiliated with the same talkgroup and maintains registration information for communication devices 140 operating in different broadcast areas 130. The PTX communication server 150 maintains registration information as communication devices 140 register and deregister with the PTX communication server 150 using unicast control channels, allowing the server 150 to track registrations and control system elements to establish push-to-talk communications sessions. The PTX communication server 150 tracks talkgroup subscription information that identifies each talkgroup by a unique talkgroup identifier and associates each talkgroup with its member devices, where each member is identified by a unique identifier such as a device identifier (ID), hardware ID, Media Access Control (MAC) address, Internet Protocol (IP) address, radio ID, International Mobile Subscriber Identity (IMSI), serial number, phone number, user name or other identifier. The PTX communication server 150 also tracks language preferences for each communication device 140. For example, in broadcast area 130-1, the PTX communication server 150 may track that ‘30’ users prefer English and ‘45’ users prefer Spanish, while in area 130-2, 70 users prefer French.

The BMSC server 160 includes hardware and software components for scheduling and transmission of broadcast content received from the PTX communication server 150. The PTX communication server 150 interfaces with the BMSC server 160 to enable broadcast delivery of PTT communications through two standardized interfaces: the mobility broadcast control (MB2-C) interface for establishing and managing broadcast bearers and TMGIs in each SAI, and the mobility broadcast user plane (MB2-U) interface for transmitting the actual broadcast data streams over the established bearers. The BMSC server 160 may be physically co-located with other network components like the eMBMS gateway 170 or may operate as a standalone network element.

In the multi-TMGI embodiment, when a PTT call is established, the PTX communication server 150 coordinates with the BMSC server 160 to establish separate TMGIs for each language in each broadcast area 130. For example, TMGI-11 is allocated for English and TMGI-12 is allocated for Spanish broadcasts in area 130-1 (e.g., requiring 2X Kilobits per second (Kbps) bandwidth), while TMGI-23 is allocated for French broadcasts in area 130-2 (e.g., requiring X Kbps bandwidth). The BMSC server 160 schedules and transmits the translated media streams over the appropriate TMGIs simultaneously, allowing efficient parallel delivery of different language streams.

In the alternate single TMGI-embodiment, the PTX communication server 150 uses a single TMGI in each broadcast area 130 with the required bandwidth. For example, TMGI-1 with 2X bandwidth in a first broadcast area 130-1, TMGI-2 with X bandwidth in a second broadcast area 130-2, and TMGI-3 with 3X bandwidth in a third broadcast area 130-3. In this case, when a PTT call is established, the BMSC server 160 receives broadcast configuration messages from the PTX communication server 150 including a list of server IP/Port addresses that will be used to deliver data streams for that group call and the associated language for each IP/Port on the single TMGI in that broadcast area.

The eMBMS gateway 170 includes hardware and software components that implement broadcast flows between the network core 110 and the broadcast stations 120 based on configurations determined by the PTX communication server 150. The PTX communication server 150 coordinates with the BMSC server 160 through 3GPP standards defined interfaces or vendor dependent interfaces to establish and manage broadcast bearers. For the multi-TMGI embodiment, the PTX communication server 150 maintains separate broadcast bearers for each language stream, managing distinct TMGIs that allow communication devices 140 to directly select their preferred language stream, with the eMBMS gateway 170 implementing these configurations. In the single-TMGI embodiment, the PTX communication server 150 manages broader bandwidth allocations that carry multiple language streams over different IP/Port combinations within a single TMGI. The PTX communication server 150 implements bandwidth management for each broadcast area, for example, managing 2X Kbps for dual-language broadcasts in area 130-1 while maintaining X Kbps for single-language delivery in area 130-2, with eMBMS gateway 170 acting as a pass-through to implement the bandwidth allocations. For 4G LTE networks, this is implemented using enhanced Multimedia Broadcast Multicast Services (eMBMS) technology, while 5G networks utilize the Media Broadcast Multicast Service (MBS) technology. The eMBMS gateway 170 may be implemented as a standalone network element or may be physically co-located with other network components.

The network core 110 also includes other network components (not shown) for controlling the operation of the communication system 100 and routing traffic within and outside of the communication system 100. These components, for example, may include a mobility management entity (MME) for authenticating and attaching communication devices 140 to the broadcast stations 120. While FIG. 1 illustrates communication through a single network core 110, the system 100 may communicate via multiple base stations and through other network cores. Additionally, while shown as a centralized system, the functionality may also be implemented in a decentralized manner within the communication device 140 or other network infrastructure.

The communication system 100 may further include additional base stations, base station controllers, router, switches, gateways, and the like, arranged, connected, and programmed to provide wireless service to communication devices 140. The communication system 100 could take the form of a public-safety radio network or commercial broadband network. The networks may implement one or more radio access technologies (RATs) and may communicate with communication device 140 over respective wireless or air-interface links according to the one or more RATs. Example RATs include a direct-mode, conventional, or infrastructure-mode trunked land-mobile-radio (LMR) standard or protocol such as European Telecommunications Standards Institute (ETSI) Digital Mobile Radio (DMR), a Project 25 (P25) standard defined by the Association of Public Safety Communications Officials International (APCO), Terrestrial Trunked Radio (TETRA), or other LMR radio protocols or standards. In other embodiments, RATs operate in accordance with standard and/or protocols such as Long Term Evolution (LTE), LTE-Advance, or 5G protocol including multimedia broadcast multicast services (MBMS) or single site point-to-multipoint (SC-PTM) over which an open mobile alliance (OMA) push to talk (PTT) over cellular (OMA-PoC), a voice over IP (VoIP), an LTE Direct or LTE Device to Device, or a PTT over IP (PoIP) application. While FIG. 1 illustrates an example, in which all devices 140 use the same RAT, in other embodiments, each communication device 140 or set of communication device 140 may use different RATs to communicate with one or more same or different infrastructure RAN.

The communication system 100 may implement, for example, a narrow-band trunked radio communication in which communications devices 140 transmit control and data messages in accordance with an air interface protocol such as that defined by the ETSI Digital Mobile Radio (DMR) or APCO25 standards. In a trunked radio communication system, frequencies are assigned for a talk group on an as-needed basis, and signaling over a control channel is used to direct communication device 140 to a particular channel to receive a particular group communication. In another embodiment, communications may implement PTT over Cellular (PoC) or PTT over IP (PoIP) broadband architecture in which communication device 140 transmit control and data messages in accordance with protocol such as real-time transport protocol (RTP) or session initiation protocol (SIP). Other possibilities exist as well. In a PoC platform, subscribers to PTT solutions (i.e., users operating PTT clients on communication device 140) may be provisioned onto the communication system via carriers (i.e., cellular carriers). PTT customers (e.g., enterprises or public safety agencies) may administer these subscribers to form closed groups for PTT communications. In one embodiment, the PoC platform may include multiple servers each supporting a different service, for example, MCPTT service, MCVideo service, or MCData service.

In accordance with some embodiments, external networks (not shown) may be made accessible to communication devices 140 via the communication network. External networks may include, for example, a public switched telephone network (PSTN), a plain old telephone (POT) system, a wide-area packet-switched network such as the Internet, or another wired or wireless service provider's network, among other possibilities.

Downlink communications over air-interface links (not shown) may be addressed to communication devices 140 (e.g., broadcast using an identifier, such as a Subscriber Group ID (SGID), that is associated with a talkgroup), and/or to one or more single communication devices 140 (e.g., unicast using an identifier, such as a Subscriber Unit Identifier (SUID), that is uniquely associated with that communication device 140), among other possibilities that are known to those of skill in the art.

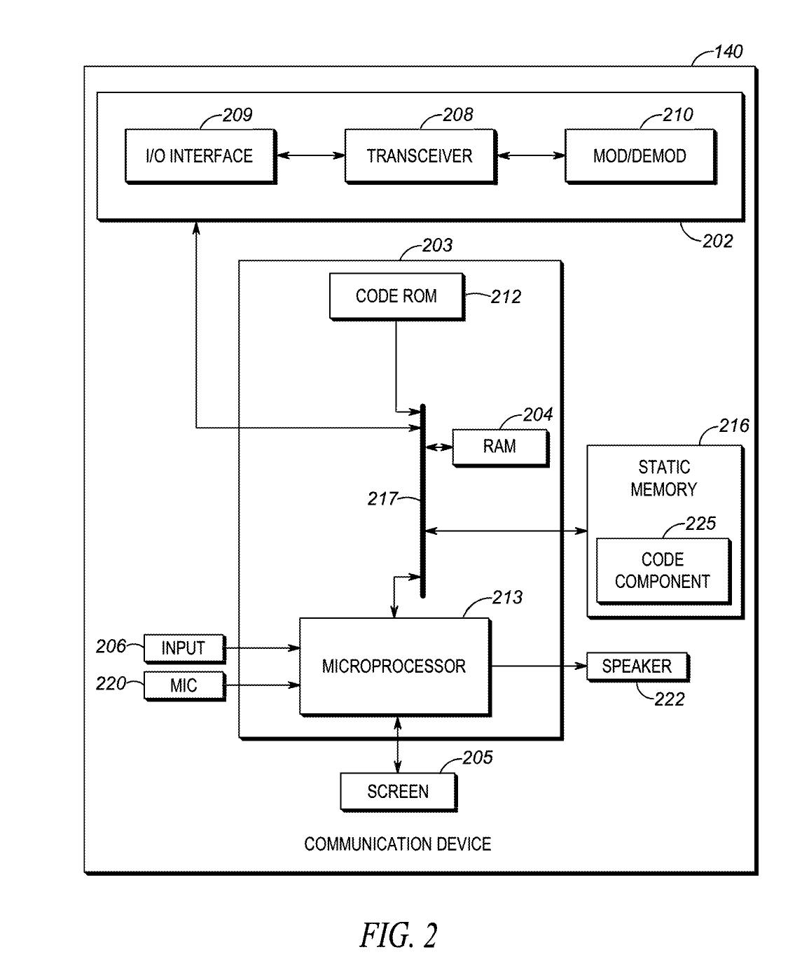

FIG. 2 is an example functional block diagram of a communication device 140 operating within the communication system 100 in accordance with some embodiments. While FIG. 2 represents a communication device 140 described above with respect to FIG. 1, depending on the type of communication device 140, the communication device 140 may include fewer or additional components in configurations different from that illustrated in FIG. 2.

As shown in FIG. 2, the communication device 140 includes a radio frequency communications unit 202 coupled to a common data and address bus 217 of a processing unit 203. The communications unit 202 may include one or more wired or wireless input/output (I/O) interfaces 209 that are configurable to communicate with other devices in or communicably coupled to the system 100. The communication device 140 may also include a display screen 205 and an input 206, each coupled to be in communication with processing unit 203. The input 206 may include an alphanumeric physical keypad (or virtual keypad in cooperation with capacitive touch display screen 205) for inputting text for communications. In accordance with some embodiments, the input 206 may include a suitable interface, for example, a hardware or graphical user interface PTT button that functions to activate a transmit function in a half-duplex communication mode, transitioning the communication device 140 (when activated) from a listen-only mode to a transmit-only mode for half-duplex communication. The display screen 205 may further function to display communications received via communications unit 202 from other devices.

A microphone 220 captures speech input from a user that is further vocoded by processing unit 203 and transmitted as voice, text, or multimedia data by communications unit 202 to other communication device 140 in the system 100. A communications speaker 222 reproduces audio that is decoded from voice data transmissions received from other communication device 140 via the communications unit 202. The communication device 140 may also further include an imaging component (not shown) such as a camera.

The processing unit 203 also includes an associated code Read Only Memory (ROM) 212 for storing data for initializing system components and encoding and/or decoding voice or other traffic information (including image data, audio data, video data, text data, control signals, etc.) that may be transmitted or received by the communication device 140. The processing unit 203 may further include a microprocessor or an electronic processor 213 coupled, by the common data and address bus 217, to a random access memory (RAM) 204, and a static memory 216.

The radio frequency communications unit 202 is a combined receiver and transmitter (e.g., transceiver) having a common antenna (not shown). The radio frequency communications unit 202 has a wireless transceiver 208 coupled to the antenna via a radio frequency amplifier. The wireless transceiver 208 may be a transceiver operating in accordance with one or more standard protocols, such as a digital mobile radio (DMR) transceiver, a Project 25 (P25) transceiver, a terrestrial trunked radio (TETRA) transceiver, a Bluetooth transceiver, a long term evolution (LTE) transceiver, a 5G transceiver, a Wi-Fi transceiver perhaps operating in accordance with an IEEE 802.11 standard (e.g., 802.11a, 802.11b, 802.11g), a WiMAX transceiver perhaps operating in accordance with an IEEE 802.16 standard, and/or other similar type of wireless transceiver configurable to communicate via a wireless network. The wireless transceiver 208 is also coupled to a combined modulator/demodulator (MOD/DEMOD) 210 that is coupled to an encoder/decoder.

The electronic processor 213 has ports for coupling to the display screen 205 and to the input 206. The electronic processor 213 further has ports for coupling to the microphone 220 and to the speaker 222. The electronic processor 213 includes one or more of a microprocessor, a logic circuit, an application-specific integrated circuit (ASIC), a field-programmable gate array (FPGA), or another suitable electronic device. In some embodiments, the static memory 216 may store operating code 225 for the electronic processor 213 that, when executed by the electronic processor 213, performs one or more of the operations set forth in the accompanying figures and text. Static memory 216 may comprise, for example, a hard disk drive (HDD), an optical disk drives (ODD) such as a compact disk (CD) drive or digital versatile disc (DVD) drive, a solid-state drive (SSD), a tape drive, a flash memory drive, or a tape drive, to name a few.

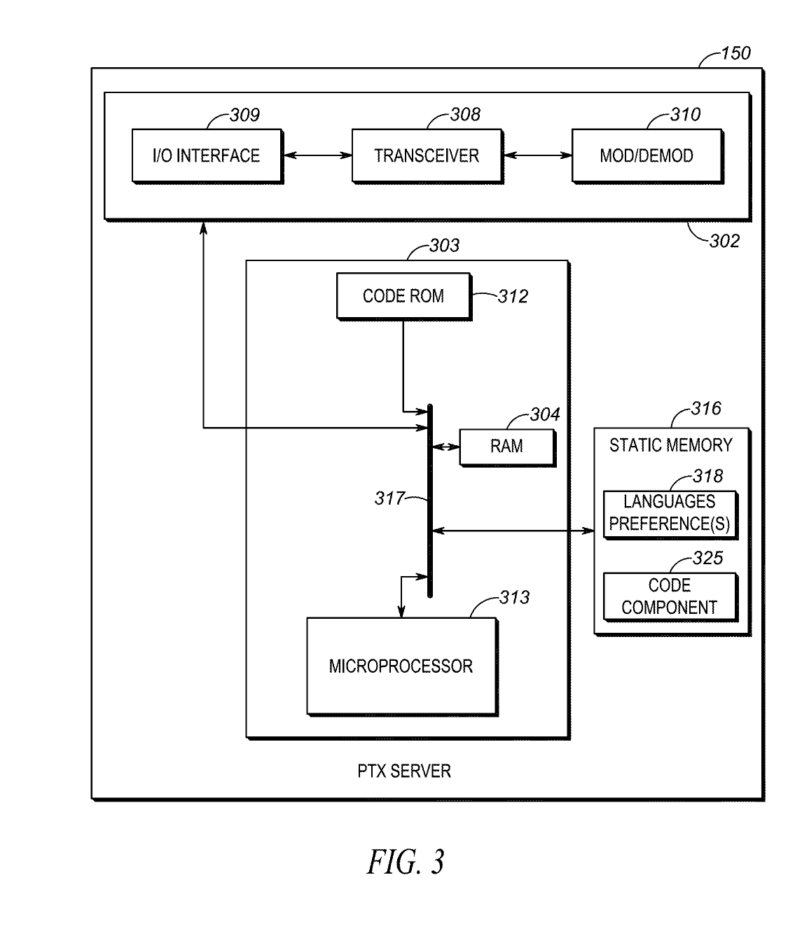

Now referring to FIG. 3, a schematic diagram illustrates a PTX communication server 150 shown in FIG. 1 in accordance with some embodiments. The PTX communication server 150 may be a standalone device or alternatively embodied in one or more other computing devices. In one embodiment, one or more of the functions of the PTX communication server 150 may be implemented at one or more of the communication devices 140 participating in a talkgroup. In one embodiment, the PTX communication server 150 may be implemented as a distributed computing device across two or more of the foregoing (or multiple of the same type of one of the foregoing) and linked via a wired and/or wireless communication link(s). The PTX communication server 150 may also be implemented in a cloud computing platform. Depending on the type of the server, the PTX communication server 150 may include fewer or additional components in configurations different from that illustrated in FIG. 3.

As shown in FIG. 3, the PTX communication server 150 includes a communications unit or communications interface 302 coupled to a common data and address bus 317 of the processing unit 303. The communications unit 302 may include one or more wired or wireless input/output (I/O) interfaces 309 that are configurable to communicate with communication devices 140 and/or with other devices in or communicably coupled to the system 100. The communications unit 302 may include one or more wireless transceivers 308, such as a DMR transceiver, a P25 transceiver, a Bluetooth transceiver, a Wi-Fi transceiver perhaps operating in accordance with an IEEE 802.11 standard (e.g., 802.11a, 802.11b, 802.11g), a WiMAX transceiver perhaps operating in accordance with an IEEE 802.16 standard, an LTE or 5G transceiver, and/or other similar type of wireless transceiver configurable to communicate via a wireless radio network. The communications unit 302 may additionally include one or more wireline transceivers 308, such as an Ethernet transceiver, a Universal Serial Bus (USB) transceiver, or similar transceiver configurable to communicate via a twisted pair wire, a coaxial cable, a fiber-optic link or a similar physical connection to a wireline network. The transceiver 308 is also coupled to a combined modulator/demodulator 310 that is coupled to the processing unit 303.

The processing unit 303 may include an encoder/decoder with an associated code Read Only Memory (ROM) 312 for storing data for initializing system components, and encoding and/or decoding voice, data, control, or other signals that may be transmitted or received between the PTX communication server 150 and other devices in the system 100. The processing unit 303 includes an electronic processor or microprocessor 313 coupled, by the common data and address bus 317, to a Random Access Memory (RAM) 304, and a static memory 316.

Static memory 316 may comprise, for example, a hard-disk drive (HDD), an optical disk drive such as a compact disk (CD) drive or digital versatile disk (DVD) drive, a solid state drive (SSD), a tape drive, a flash memory drive, or a tape drive, to name a few. Static memory 316 stores operating code 325 for the electronic processor 313 that, when executed, performs one or more of the functions set forth in the figures and accompanying text. Static memory 316 may additionally store (or PTX communication server 150 has access to, via the communications unit 302) language preference information 318 identifying, for each communication device 140 affiliated with a communication group or talkgroup, a language preference indicating a desired language for receiving group communications. The static memory 316 may also store talkgroup subscription information identifying communication devices 140 that are affiliated with each talkgroup managed by the PTX communication server 150.

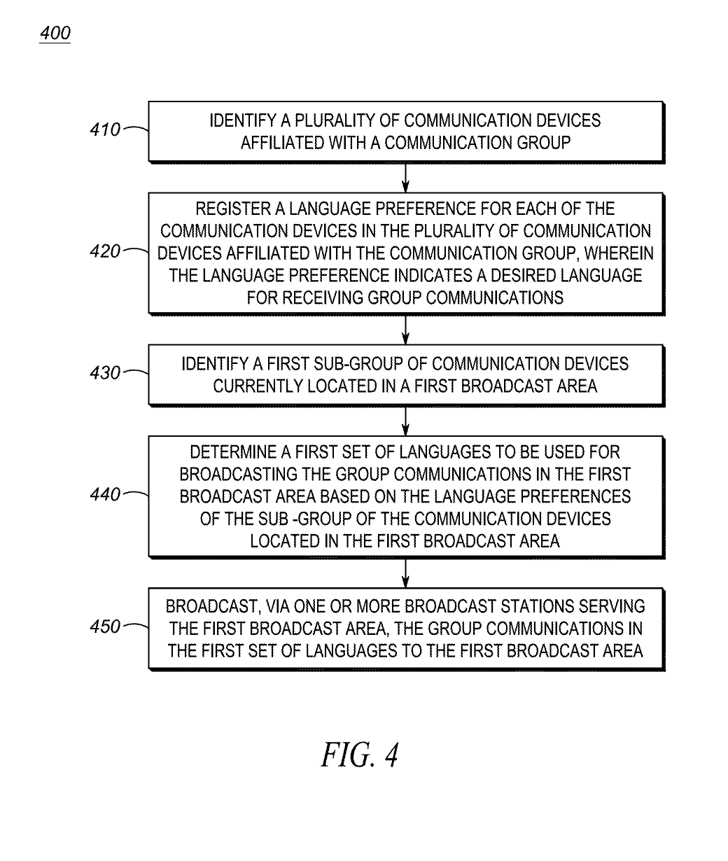

Turning now to FIG. 4, a flowchart diagram illustrates a process 400 for broadcasting communications in a group communication system 100. While a particular order of processing steps, message receptions, and/or message transmissions is indicated in FIG. 4 as an example, timing and ordering of such steps, receptions, and transmissions may vary where appropriate without negating the purpose and advantages of the examples set forth in detail throughout the remainder of this disclosure. A PTX communication server 150 as set forth in FIG. 3 executes process 400 in accordance with some embodiments. The PTX communication server 150 may execute the process 400 at power-on, at some predetermined periodic time period thereafter, in response to a trigger raised locally at the PTX communication server 150 via an internal process (e.g., in response to detecting that a group call is to be established between members of a talk group), or via an input interface (e.g., a talkgroup administrator enabling a particular feature associated with the process 400 by activating a button at the PTX communication server 150), among other possibilities.

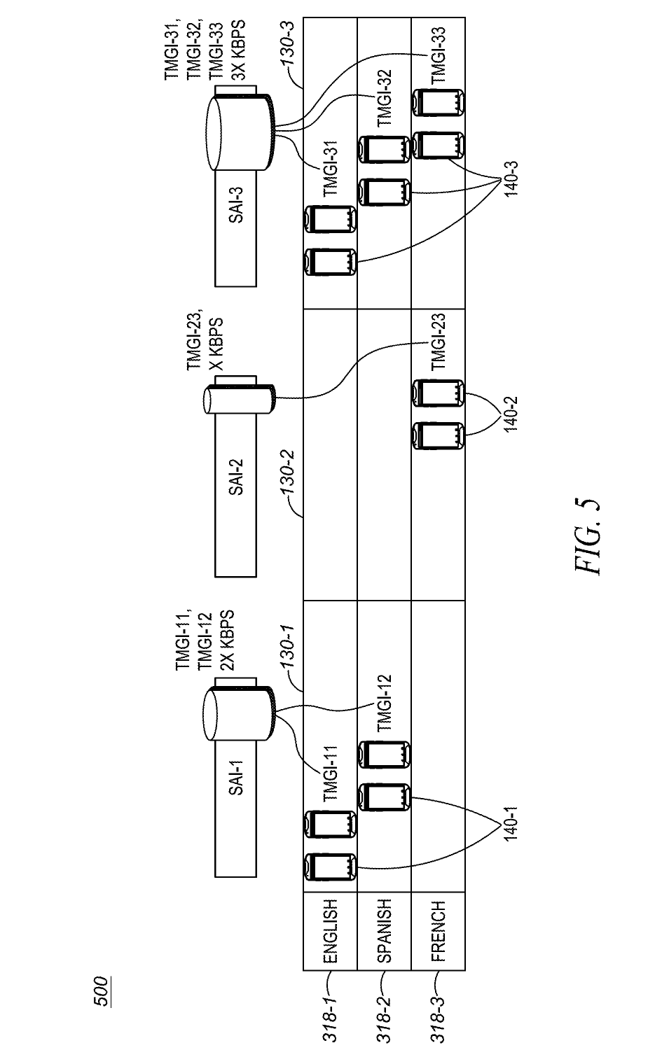

The process 400 of FIG. 4 need not be performed in the exact sequence as shown and likewise various blocks may be performed in different order or alternatively in parallel rather than in sequence. Accordingly, the elements are referred to herein as “blocks” rather than “steps.” The process 400 may be implemented on variations of the system 100 of FIG. 1 as well. The process 400 is further described herein with reference to FIG. 5, which illustrates broadcast channel allocation 500 across multiple broadcast areas.

Process 400 begins at block 410 when the PTX communication server 150 identifies a plurality of communication devices 140 affiliated with a communication group. In one embodiment, before executing the identification process, the PTX communication server 150 verifies whether broadcast services for broadcasting communications in multiple languages are enabled for the communication group. This verification is performed by accessing configuration settings stored in static memory 316 that specify which communication groups are authorized for multilingual broadcasts. The PTX communication server 150 may maintain group-specific settings that indicate whether translation and broadcast capabilities have been enabled (e.g., by system administrators), along with any associated parameters such as maximum number of supported languages or bandwidth allocations for broadcast streams.

After verifying that broadcast services are authorized for a communication group, the PTX communication server 150 identifies communication devices affiliated with the communication group. The PTX communication server 150 selects a particular communication group for processing based on various triggers including: establishment of a new PTT call for the group, receipt of a request to generate a broadcast configuration message (also referred to as a MapGroupToBearerRequest message), detection of changes in group affiliation information, or receipt of device registration updates. The PTX communication server 150 also processes late-joining communication devices 140 that either power-up and join an ongoing call or change their group affiliation during an active call. When a communication device 140 late-joins an ongoing call, the PTX communication server 150 evaluates the communication device’s language preference and updates the set of required languages for the device’s current broadcast area if needed. For example, if a Spanish-speaking user powers up their communication device 140 and joins an ongoing call in a broadcast area that was only broadcasting English content, if a threshold number of users (e.g., 1 user or greater than 1 user) requiring the new language accumulates in the new broadcast area, the PTX communication server 150 updates that broadcast area’s language requirements to include Spanish broadcasts.

Additionally, the PTX communication server 150 monitors mobility of communication devices 140 during ongoing calls. When communication devices 140 move between broadcast areas 130, the server 150 evaluates if the devices’ language preferences are supported in a new broadcast area. If a threshold number of users requiring a particular language accumulates in the new broadcast area, the PTX communication server 150 dynamically updates the new broadcast area’s broadcast configuration to include the additional language. For example, if multiple French-speaking users move into a new broadcast area that was only broadcasting English content, once the number of French-speaking users exceeds a defined threshold (e.g., 5 users), the PTX communication server 150 establishes broadcast resources to support French language delivery in the new broadcast area.

When a new PTT call is established for a particular communication group, the PTX communication server 150 identifies communication devices 140 affiliated with the particular communication group to determine language requirements and optimize broadcast resource allocation across different broadcast areas or SAIs. Similarly, when preparing to generate a broadcast configuration message, the PTX communication server 150 identifies affiliated communication devices 140 to properly configure TMGIs and associated language mappings for each broadcast area.

After identifying the appropriate communication group and verifying that broadcast services are authorized for the communication group, the PTX communication server 150 identifies affiliated communication devices using talkgroup subscription information (e.g., stored in static memory 316). The talkgroup subscription information associates each talkgroup with its member devices using unique identifiers such as device IDs, hardware IDs, Media Access Control (MAC) addresses, Internet Protocol (IP) addresses, radio IDs, International Mobile Subscriber Identity (IMSI), serial numbers, phone numbers or usernames.

At block 420, the PTX communication server 150 registers a language preference for each of the communication devices affiliated with the communication group. The PTX communication server 150 may register and maintain language preferences as part of the language preference information 318 in static memory 316, creating a data structure that links each communication device’s unique identifier with their desired language for receiving group communications.

Language preferences can be configured through multiple mechanisms. For example, when communication devices 140 first register with the PTX communication server 150 using unicast control channels, users can select their preferred language through the communication device interface. The communication device’s user interface enables options to set and modify language preferences for receiving translated group communications. Language preferences can also be configured by system administrators through device provisioning or batch configuration processes. Additionally, language preferences can be configured based on talkgroup affiliations. These configured language preferences are then transmitted to the PTX communication server 150 and may be maintained in the language preference information 318 stored in the static memory 316. Users can also update their language preferences through the device interface at any time. When a user selects a different language, the communication device 140 sends an update to the PTX communication server 150, which then modifies the stored preference in the language preference information 318. This allows users to dynamically change their preferred language for receiving group communications. In another embodiment, the PTX communication server 150 works with translation engines to automatically detect and register language preferences. When communication devices 140 first connect to the system 100, the translation engines analyze initial communications from each device to automatically detect the source language of the initial communications. The detected source language information is then provided to the PTX communication server 150, which automatically configures the language preference for the communication devices. Users can still modify these automatically detected language preferences through the device interface at any time.

When group communications are initiated, the PTX communication server 150 uses registered language preferences to determine which languages require translation services. If the source language of communications differs from the registered preferences, the PTX communication server 150 employs translation engines to automatically convert the communications from the source language to the required target languages in real-time.

At block 430, the PTX communication server 150 identifies a first sub-group of communication devices currently located in a first broadcast area. The first sub-group of communication devices consists of those communication devices that are both affiliated with the communication group and currently located within the first broadcast area. For example, as shown in FIG. 1, communication devices 140-1 that are operating within broadcast area 130-1 are identified as part of the first sub-group. The PTX communication server 150 determines membership in the first sub-group by cross-referencing the device’s group affiliation status with their current location information. The PTX communication server 150 maintains registration information as devices 140 register and deregister using unicast control channels, tracking which affiliated devices are active within specific broadcast areas or Service Area Identifiers (SAIs). For instance, if the PTX communication server 150 identifies ‘75’ total devices affiliated with the communication group in broadcast area 130-1 (SAI-1), with ‘30’ devices configured for English and ‘45’ devices configured for Spanish, then these ‘75’ devices would constitute the first sub-group of communication devices. The PTX communication server 150 maintains these device-to-SAI mappings and updates them when communication devices 140 move between broadcast areas, register with new broadcast stations 120, or change their network connections.

The PTX communication server 150 tracks locations of the communication devices 140 through multiple mechanisms to map communication devices 140 to their respective broadcast areas. One method involves tracking broadcast station 120 associations, where each broadcast station 120 serves a defined broadcast area 130. As communication devices 140 connect to specific broadcast stations 120, the PTX communication server 150 maps them to corresponding broadcast areas. For instance, communication devices 140-2 connected to broadcast station 120-2 are mapped to broadcast area 130-2. Another method involves the PTX communication server 150 using global positioning system (GPS) coordinates provided by communication devices 140 to determine their location within broadcast areas. The PTX communication server 150 may also employ network-based positioning methods such as cell tower triangulation, which uses signal strength measurements from multiple broadcast stations 120 to calculate positions of the communication devices 140. These location tracking mechanisms enable the PTX communication server 150 to maintain accurate device-to-broadcast area mappings even as communication devices 140 move between different broadcast areas.

In 3GPP networks, the broadcast areas are implemented as SAIs, where each SAI represents a defined coverage region for delivering broadcast content. The PTX communication server 150 maintains current device-to-SAI mappings to ensure proper delivery of group communications. These mappings are updated when devices move between broadcast areas, register with new base stations, or change their network connections.

At block 440, the PTX communication server 150 determines a first set of languages to be used for broadcasting group communications in the first broadcast area 130-1 based on the language preferences of the first sub-group of communication devices 140-1 located in that area. The first set of languages represents the unique set of desired languages registered for communication devices 140-1 in the first sub-group. For example, in broadcast area 130-1, if 30 devices have registered English as their preferred language and ‘45’ devices have registered Spanish as their preferred language, the first set of languages would comprise English and Spanish. The PTX communication server 150 analyzes the language preference information 318 stored in static memory 316 to identify these required languages.

When determining the first set of languages, the PTX communication server 150 considers the source language of the group communications. If the source language differs from any of the registered language preferences, the server 150 employs translation engines to automatically convert communications from the source language to the required target languages in real-time. For instance, if a Spanish-speaking member transmits communications that need to be delivered to English-language recipients in broadcast area 130-1, the server 150 first translates the Spanish source content into English before broadcasting.

The PTX communication server 150 stores a record of language determination data (i.e., first set of languages determined at block 440) in conjunction with device location information (determined at block 430), tracking the specific number of communication devices 140 requiring each language within the broadcast area. For example, the PTX communication server 150 tracks that broadcast area 130-1 (SAI-1) contains ‘75’ total devices affiliated with a talkgroup, with ‘30’ communication devices configured to receive group communications in English and ‘45’ communication devices configured to receive group communications in Spanish. The PTX communication server 150 continuously updates these records as communication devices 140 move between broadcast areas or modify their language preferences. When communication devices 140 register with new broadcast stations or change their network connections, the PTX communication server 150 updates the device-to-SAI mappings. Similarly, when users update their language preferences through the device user interface, the server 150 modifies the stored preferences in the language preference information 318. This dynamic tracking ensures the PTX communication server 150 maintains current information about language requirements for each broadcast area.

At block 450, the PTX communication server 150 broadcasts the group communications in the first set of languages to the first broadcast area 130-1 via one or more broadcast stations 120-1 serving that area. The group communications may include voice, text, video, image content or other media types exchanged between members of the defined talkgroup. These communications are typically initiated when a member activates a push-to-talk input to transmit to other talkgroup members.

Before broadcasting, the PTX communication server 150 determines whether translation is needed by comparing the source language of communications with the required target languages in the first set. When the source language matches the language preferences of all communication devices 140 in the first broadcast area, the PTX communication server 150 can bypass the translation engines and directly prepare the communications for broadcast delivery. In this case, the PTX communication server 150 routes the communication directly to the broadcast delivery system and establishes a single TMGI or IP/Port combination for the original language stream.

When the source language differs from one or more target languages in the first set, translation is required before broadcasting the communications to the first broadcast area 130-1. In this case, the PTX communication server 150 employs translation engines to automatically convert communications from the source language to the target languages. For each target language required to be translated in the broadcast area (e.g., English and Spanish in broadcast area 130-1), the PTX communication server 150 maintains a separate translation queue to process incoming communications in an ordered manner. The translation engines process communications through these queues sequentially, with timing control to ensure synchronized delivery across language versions. For example, when a Spanish-speaking member transmits communications that need English delivery in broadcast area 130-1, the translation engine processes the content through the English translation queue while maintaining timing markers to synchronize with the original Spanish stream.

The translation queues interface with the broadcast delivery system through the BMSC server 160 and eMBMS gateway 170. The broadcast delivery system maintains synchronized timing by tracking transmission timestamps and applying consistent processing delays across all language versions. In the multi-TMGI embodiment, the processed translations feed into separate synchronized TMGIs (e.g., TMGI-11 for English and TMGI-12 for Spanish), while in the single-TMGI embodiment, they feed into different IP/port combinations within the same TMGI.

To facilitate broadcast delivery of different language streams, the PTX communication server 150 coordinates with the BMSC server 160, for example, through standardized 3GPP interfaces. The MB2-C (control) interface establishes and manages the broadcast bearers and TMGIs for each broadcast area or SAI, configuring the underlying broadcast infrastructure. The MB2-U (user plane) interface then handles the transmission of the actual communications over these established bearers, delivering the content to the first sub-group of communication devices 140-1 in the first broadcast area 130-1.

To establish broadcast channels for delivering communications in multiple languages, the PTX communication server 150 sends control information to each communication device included in the first sub-group of communication devices 140-1. The control information identifies a specific broadcast channel that the communication devices 140-1 in the first sub-group should use for receiving group communications in its broadcast area. This control information is transmitted, for example: (1) during initial device registration using unicast control channels when communication devices first connect to the network, (2) at call start and periodically retransmitted during the call on a control channel (e.g., General Purpose Multicast Subchannel TMGI or GPMS TMGI), or (3) whenever broadcast configurations change due to updates in language preferences or device movement between broadcast areas. The GPMS TMGI is a dedicated control channel that is separate from TMGI’s used for delivering the actual language-specific content streams. While TMGIs like TMGI-11 and TMGI-12 carry the translated audio content in different languages, the GPMS TMGI is reserved for delivering control messages to enable communication devices 140 identify and switch between content-carrying TMGIs. In addition, the PTX communication server 150 may dynamically assign different TMGIs and/or Server IP/Port combinations for each new call. For example, a first call may use TMGI-11 for English content while a subsequent call for the same group may be assigned TMGI-13, or a different Server IP/Port combination may be allocated within the same TMGI. The control information is transmitted through enhanced broadcast configuration messages (e.g., MapGroupToBearerRequest) and includes information enabling communication devices 140 to receive broadcasts in their preferred languages. Upon receiving this control information, communication devices 140 identify their assigned TMGI or IP/port combination based on their language preference, configure their receivers accordingly, and begin receiving group communications in their preferred language. The MB2-C interface is used to establish and manage the broadcast bearers and TMGIs for delivering the control information.

The PTX communication server 150 analyzes the language preference information 318 stored in static memory 316 to determine whether communication devices 140 in a broadcast area form distinct subsets based on their language preferences. When multiple language preferences exist within a broadcast area 130, the PTX communication server 150 determines that a first subset of communication devices in the first sub-group indicate a common language preference corresponding to a first language included in the set of languages, while a second subset indicate a common preference corresponding to a second language. For example, in broadcast area 130-1, the PTX communication server 150 may identify two distinct subsets of communication devices with a first subset of communication devices preferring English and a second subset of communication devices preferring Spanish.

The PTX communication server 150 implements broadcast channel allocation and language switching through two different embodiments. In the multi TMGI-embodiment, the PTX communication server 150 allocates dedicated broadcast channels, for example, a first broadcast channel for broadcasting the group communications in the first language and a second broadcast channel for broadcasting the group communications in the second language. As shown in FIG. 5, the PTX communication server 150 implements bandwidth-optimized broadcast channel allocation across broadcast areas based on the number of required language streams. For example, in broadcast area 130-1 or SAI-1, the PTX communication server 150 allocates 2X Kbps bandwidth to support two simultaneous language streams, for example, English content delivered via TMGI-11 to ‘30’ users (318-1), Spanish content delivered via TMGI-12 to ‘45’ users (318-2). In contrast, broadcast area SAI-2 requires only X Kbps bandwidth since it supports a single French language stream (318-3) via TMGI-23. The bandwidth allocation scales linearly with the number of required language streams, with broadcast area SAI-3 requiring 3X Kbps to support English (TMGI-31), Spanish (TMGI-32), and French (TMGI-33) streams for communication devices 140-3. The PTX communication server 150 coordinates with the BMSC server 160 through the MB2-C interface to establish synchronized broadcast bearers that ensure all versions of the same communication are delivered with consistent timing across different bearers.

The PTX communication server 150 sends control information identifying a first channel identifier associated with the first broadcast channel to the first subset of communication devices and control information identifying a second channel identifier associated with the second broadcast channel to the second subset of communication devices. As shown in FIG. 5, for broadcast area 130-1, the PTX communication server 150 establishes TMGI-11 and TMGI-12 as the first and second channel identifiers respectively. In contrast to areas requiring multiple language support, some broadcast areas contain only one subset of devices sharing a common language preference. For example, broadcast area 130-2 requires allocation of a single channel identifier (TMGI-23) for French language content. In one embodiment, the PTX communication server 150 sends control information to each subset identifying their corresponding channel identifier, while also including information about the other available channel identifier and its associated language. For example, the control information sent to communication devices in the first subset includes both TMGI-11 for receiving English broadcasts and TMGI-12 with an indication that it broadcasts Spanish communications. This dual-channel configuration enables devices to dynamically switch between TMGIs to receive different language versions while maintaining synchronized reception.

Alternatively, in the single-TMGI embodiment, the PTX communication server 150 analyzes the language preferences to identify distinct subsets within the first sub-group of communication devices. The PTX communication server 150 determines that a first subset of communication devices indicates a common language preference for a first language, while a second subset of communication devices shares a common preference for a second language. For example, in broadcast area 130-1, the server 150 identifies one subset preferring English and another preferring Spanish. Rather than allocating separate channels, the PTX communication server 150 allocates a single broadcast channel for broadcasting communications in both languages. The PTX communication server 150 then sends control information to both the first and second subsets of communication devices that includes: (1) a channel identifier associated with the single broadcast channel, and (2) a list of resource addresses that identify specific resources from which communications in either the first or second language can be retrieved. These resource addresses include internet protocol (IP) addresses and port numbers, or combinations thereof. For example, in broadcast area 130-1, the control information includes TMGI-1 as the channel identifier along with IP1/Port1 for retrieving English streams and IP2/Port2 for Spanish streams. The PTX communication server 150 maintains synchronized delivery by coordinating the transmission timing across these IP/Port combinations, ensuring all language versions of the same communication are delivered with consistent timing within the single TMGI. This configuration enables communication devices 140 to switch between languages by selecting different IP/Port combinations while maintaining connection to the same broadcast channel or TMGI.

The PTX communication server 150 configures the communication devices 140 based on their subset membership. In the multi-TMGI embodiment, the first subset of communication devices are configured to switch to the first broadcast channel using the first channel identifier (e.g., TMGI-11) to receive communications in the first language (e.g., English), while the second subset of communication devices are configured to use the second channel identifier (e.g., TMGI-12) for the second language (Spanish). In broadcast areas with only one subset of devices sharing a common language preference, like broadcast area 130-2, the server 150 allocates a single channel identifier (TMGI-23) for that language.

In the single-TMGI embodiment, the PTX communication server 150 configures both subsets of communication devices to use a unified broadcast channel while enabling language-specific content retrieval. The PTX communication server 150 configures the first subset of communication devices to switch to the single broadcast channel using the provided channel identifier and retrieve group communications in their preferred first language using the designated resource addresses from the provided list. Similarly, the second subset of communication devices are configured to use the same channel identifier but retrieve group communications in their preferred second language using a different resource address from the list. For example, in broadcast area 130-1, devices preferring English are configured to use IP1/Port1 while devices preferring Spanish use IP2/Port2, all operating on the same TMGI-1. This configuration enables efficient resource utilization while maintaining the flexibility for users to switch between available language streams by selecting different IP/Port combinations within the same broadcast channel.

To optimize broadcast resource utilization, when broadcasting group communications to the first broadcast area 130-1, the PTX communication server 150 refrains from broadcasting communications in any language other than the first set of languages to the broadcast area. For example, if the first set of languages for the first broadcast area 130-1 includes only English and Spanish based on the registered preferences of affiliated devices in that area (e.g., ‘30’ devices configured for English and ‘45’ devices for Spanish), the PTX communication server 150 will not broadcast communications in other languages like French to the first broadcast area 130-1, even if French translations are being generated for other broadcast areas. This selective language broadcasting is implemented by the PTX communication server 150 through the BMSC server 160 and eMBMS gateway 170 by only establishing TMGIs or IP/Port combinations for the required languages in each broadcast area. In the multi-TMGI embodiment, only TMGI-11 for English and TMGI-12 for Spanish would be established for broadcast area 130-1. Similarly, in the single-TMGI embodiment, the allocated TMGI would only include IP/port pairs for English and Spanish streams.

The PTX communication server 150 monitors movement of communication devices 140 between broadcast areas 130 and dynamically updates language requirements accordingly. When the PTX communication server 150 determines that a particular communication device from the first sub-group has moved from the first broadcast area 130-1 to the second broadcast area 130-2, the PTX communication server 150 evaluates whether the device’s registered language preference is supported in the new location. For example, if a communication device 140 configured for English moves from broadcast area 130-1 (where English is part of the first set of languages) to broadcast area 130-2 (where only French is currently being broadcast), the PTX communication server 150 determines that the second set of languages does not include the particular language (i.e., English) indicated in the communication device’s registered language preference. Upon detecting this language mismatch, the PTX communication server 150 updates the second set of languages (to be broadcasted to broadcast area 130-2) to include English. The PTX communication server 150 coordinates with the BMSC server 160 to establish additional broadcast resources in broadcast area 130-2 by either allocating a new TMGI (or using a spare TMGI available or spare bandwidth available in an existing TMGI in that broadcast area 130-2, for example, assigned previously to a completed call in the broadcast area 130-2) for English broadcasts in the multi-TMGI embodiment or by adding an English IP/port combination to the existing TMGI in the single-TMGI embodiment. After updating the second set of languages, the PTX communication server 150 broadcasts subsequent group communications intended for the communication group in both French and English to broadcast area 130-2. This ensures the communication device 140 continues receiving communications in its preferred language after moving from the first broadcast area 130-1 to the second broadcast area 130-2 while maintaining service to existing devices in the second broadcast area 130-2. The server 150 implements this dynamic language updating through the MB2-C interface, establishing new broadcast bearers as needed, while using the MB2-U interface to transmit the additional language streams. The translation queues and synchronization mechanisms ensure the newly added language stream maintains proper timing alignment with existing streams in the broadcast area.

The PTX communication server 150 may further identify a second sub-group of communication devices currently located in a second broadcast area. Similar to the first sub-group, the second sub-group consists of communication devices that are both affiliated with the communication group and currently located within the second broadcast area. For example, as shown in FIG. 1, communication devices 140-2 operating within broadcast area 130-2 are identified as part of the second sub-group. The PTX communication server 150 determines a second set of languages to be used for broadcasting group communications in the second broadcast area based on the language preferences of the second sub-group. For example, if 70 devices in broadcast area 130-2 have registered French as their preferred language, the second set of languages would comprise French. The PTX communication server 150 analyzes the language preference information 318 stored in static memory 316 to identify these required languages for the second broadcast area. The PTX communication server 150 then broadcasts the group communications in the second set of languages to the second broadcast area 130-2 via one or more broadcast stations 120-2 serving that area. In this example, the PTX communication server 150 coordinates with the BMSC server 160 to establish TMGI-23 for French broadcasts in area 130-2. To optimize broadcast resources, the PTX communication server 150 refrains from broadcasting communications in any language other than the second set of languages to the second broadcast area 130-2. For example, the PTX communication server 150 does not broadcast communications in any language other than French (the second set of languages) to broadcast area 130-2, even though English and Spanish translations may be available for other areas. The second set of languages broadcasted to the second broadcast area may include at least one language that is different from the first set of languages broadcasted to the first broadcast area. For instance, while broadcast area 130-1 receives broadcasts in English and Spanish (first set of languages), broadcast area 130-2 receives broadcasts only in French (second set of languages). This allows the PTX communication server 150 to tailor the broadcast languages to the specific language preferences of devices in each broadcast area while optimizing resource utilization by not broadcasting unused language versions. The broadcast delivery to the second broadcast area follows similar mechanisms as the first broadcast area, with the PTX communication server 150 coordinating with the BMSC server 160 through the MB2-C and MB2-U interfaces to establish and manage appropriate TMGIs or IP/Port combinations for the required language streams.

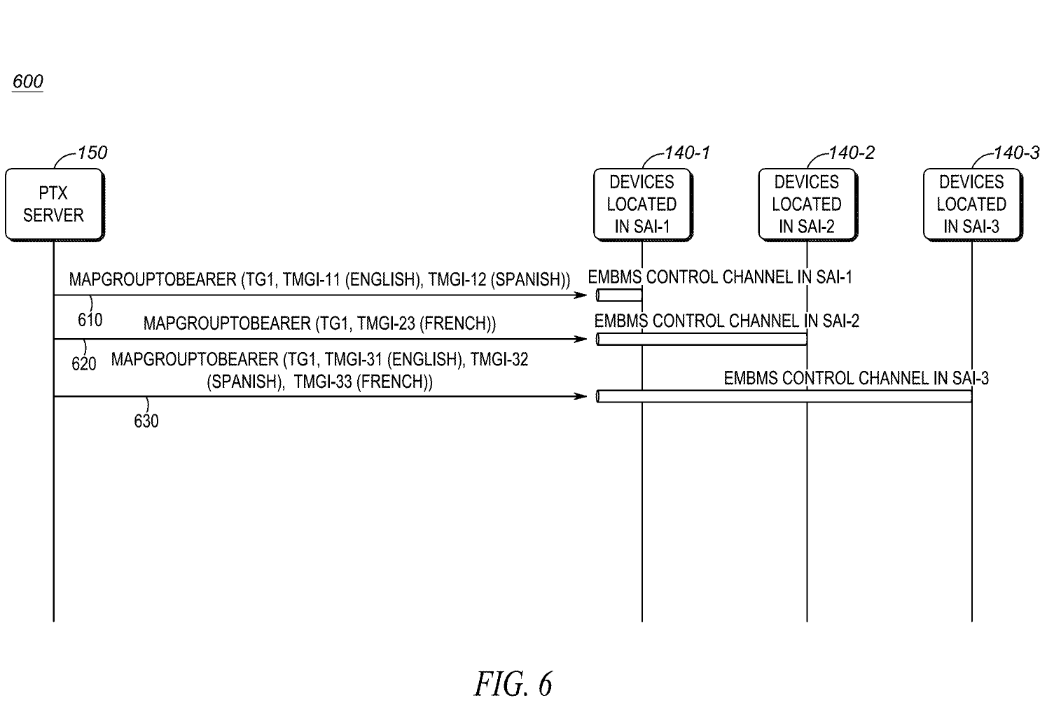

FIG. 6 illustrates a message flow diagram 600 showing communications between the PTX communication server 150 and communication devices 140 located in different broadcast areas for implementing the multi-TMGI embodiment.

The sequence begins with the PTX communication server 150 sending enhanced broadcast configuration messages (e.g., MapGroupToBearerRequest messages) over the eMBMS control channel to communication devices 140 located in each broadcast area. For communication devices 140-1 located in broadcast area 130-1 or SAI-1, message 610 contains TMGI-11 for English and TMGI-12 for Spanish broadcasts, reflecting the language preferences of communication devices 140-1 located in that area 130-1 For communication devices 140-2 located in broadcast area 130-2 or SAI-2, the PTX communication server 150 sends a message 620 containing TMGI-23 for French content, as this area only requires a single language stream. Similarly, communication devices 140-3 located in broadcast area 130-3 or SAI-3 receive message 630 containing TMGI-31, TMGI-32, and TMGI-33 for English, Spanish, and French respectively, supporting all three language requirements in that broadcast area. Each of the broadcast configuration messages 610, 620, and 630 additionally includes information identifying a particular talkgroup (e.g., TG1) to which the communication devices 140-1, 140-2, and 140-3 located in the broadcast areas 130-1, 130-2, and 130-3, respectively, are affiliated with.

The PTX communication server 150 coordinates these message flows through the BMSC server 160 and eMBMS gateway 170 using the MB2-C interface to establish and manage the broadcast bearers. The control messages may be transmitted during (1) initial device registration using unicast control channels when communication devices 140 first connect to the network, (2) at call start and periodically retransmitted (e.g., every 500 milliseconds) throughout the call, or (3) whenever broadcast configurations change due to updates in language preferences or device movement between broadcast areas.

Upon receiving the control messages, communication devices 140 identify their assigned TMGI based on their configured language preference and begin monitoring the appropriate broadcast channel. The dual-channel configuration in areas like broadcast area 130-1 or SAI-1 and broadcast area 130-3 or SAI-3 enables devices to dynamically switch between TMGIs to receive different language versions while maintaining synchronized reception. The PTX communication server 150 maintains synchronized delivery by coordinating with the BMSC server 160 through the MB2-C interface to establish synchronized broadcast bearers that ensure all versions of the same communication are delivered with consistent timing across different TMGIs.

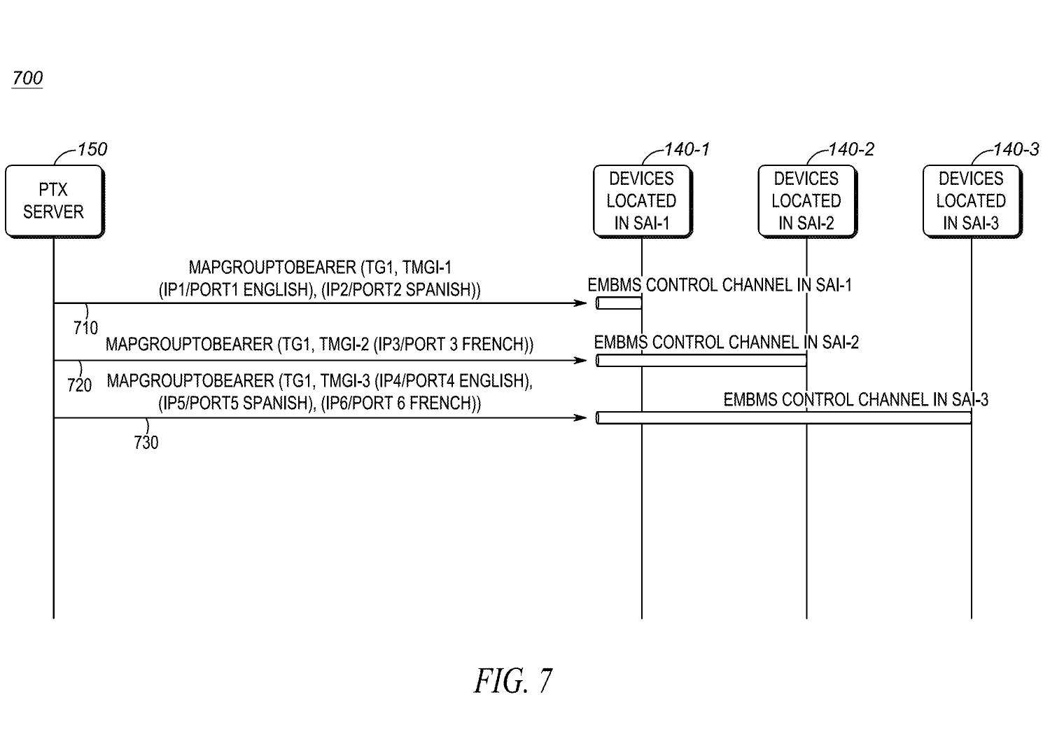

FIG. 7 illustrates a message flow diagram 700 showing communications between the PTX communication server 150 and communication devices 140 located in different broadcast areas for implementing the single-TMGI embodiment.

The sequence begins with the PTX communication server 150 sending enhanced broadcast configuration messages (e.g., MapGroupToBearerRequest messages) over the eMBMS control channel to communication devices 140 located in each broadcast area. For communication devices 140-1 located in broadcast area 130-1 or SAI-1, message 710 contains TMGI-1 with IP1/Port1 for English and IP2/Port2 for Spanish streams, reflecting the language preferences of communication devices 140-1 located in that area 130-1. For communication devices 140-2 located in broadcast area 130-2 or SAI-2, the PTX communication server 150 sends message 720 containing TMGI-2 with IP3/Port3 for French content, as this area only requires a single language stream. Similarly, communication devices 140-3 located in broadcast area 130-3 or SAI-3 receive message 730 containing TMGI-3 with IP4/Port4 for English, IP5/Port5 for Spanish, and IP6/Port6 for French, supporting all three language requirements in that broadcast area. Each of the broadcast configuration messages 710, 720, and 730 additionally includes information identifying a particular talkgroup (e.g., TG1) to which the communication devices 140-1, 140-2, and 140-3 located in the broadcast areas 130-1, 130-2, and 130-3, respectively, are affiliated with.

The PTX communication server 150 coordinates these message flows through the BMSC server 160 and eMBMS gateway 170 using the MB2-C interface to establish and manage the broadcast bearers. The control messages may be transmitted during (1) initial device registration using unicast control channels when communication devices 140 first connect to the network, (2) at call start and periodically retransmitted throughout the call, or (3) whenever broadcast configurations change due to updates in language preferences or device movement between broadcast areas, and periodically through the eMBMS control channel to maintain current configurations.

Upon receiving the control messages, communication devices 140 identify their assigned IP/port combination based on their configured language preference while maintaining connection to the same TMGI. The configuration in areas like broadcast area 130-1 or SAI-1 and broadcast area 130-3 or SAI-3 enables devices to switch between languages by selecting different IP/Port combinations within the same broadcast channel while maintaining synchronized reception. The PTX communication server 150 maintains synchronized delivery by coordinating the transmission timing across these IP/Port combinations, ensuring all language versions of the same communication are delivered with consistent timing within the single TMGI.

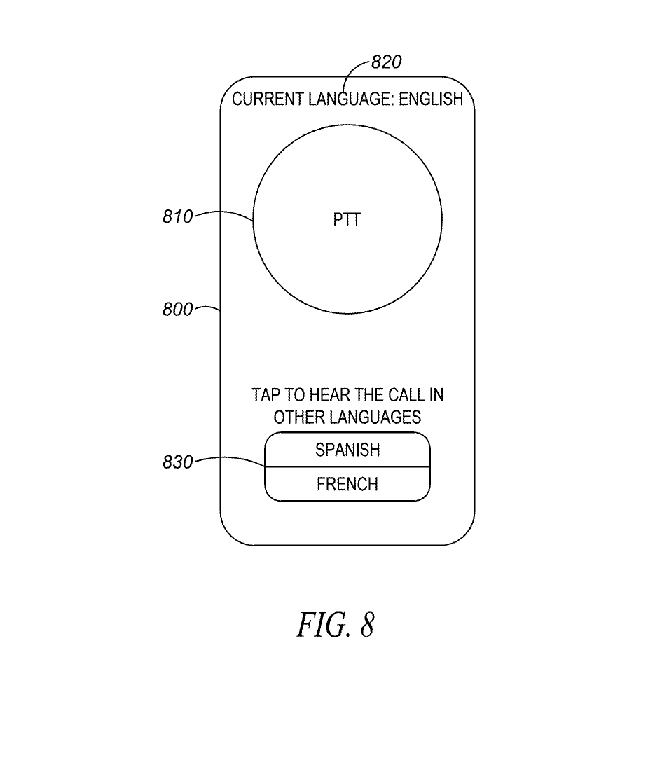

FIG. 8 illustrates a user interface 800 to switch between different languages for receiving group communications being broadcast in a current broadcast area of a user.

The user interface 800 is implemented, for example, at a communication device 140 through a client-side push-to-talk call application that provides instantaneous private and group communication functionality. The interface 800 displays the user’s current language selection 820 at the top of the screen, showing, for example, “CURRENT LANGUAGE: ENGLISH” to clearly indicate to the user which language stream the communication device 140 is currently receiving.

In addition to the current language display, the user interface 800 includes a push-to-talk (PTT) button 810 that allows users to transmit communications when activated. When the PTT button 810 is activated, the communication device 140 switches from monitor-only mode to transmit-only mode (half-duplex) or transmit and receive mode (full-duplex). The device 140 transmits a floor request to the PTX communication server 150, and upon floor grant, can begin transmitting communications to other talkgroup members.

The user interface 800 presents available language options 830 as selectable buttons. In the example shown in FIG. 8, “SPANISH” and “FRENCH” are displayed as additional languages in which the communications are currently being broadcast in a broadcast area (e.g., broadcast area 130-3) in which the user is located. These language options correspond to the different TMGIs or IP/Port combinations available in the user’s broadcast area.

When a user selects a different language option, the communication device 140 switches to the appropriate TMGI in the multi-TMGI embodiment, or to the corresponding IP/port combination in the single-TMGI embodiment, to begin receiving communications in the selected language. For example, if a user in broadcast area 130-3 currently receiving English via TMGI-31 wants to switch to Spanish, selecting the “SPANISH” option configures the communication device 140 to receive communications via TMGI-32. Similarly, if a user in broadcast area 130-3 currently receiving English via TMGI-31 wants to switch to French, selecting the “FRENCH” option configures the communication device 140 to receive communications via TMGI-33.

When communications are initiated through the PTT button 810 at a transmitting communication device 140, the PTX communication server 150 uses registered language preferences to determine which languages require translation services. If the source language differs from the registered preferences of receiving communication devices, the PTX server 150 employs translation engines to automatically convert the communications from the source language to the required target languages in real-time. For example, if a Spanish-speaking member transmits communications that need to be delivered to both English and French language recipients, the PTX communication server 150 first translates the Spanish source content into the required target languages before broadcasting through the appropriate TMGIs or IP/port combinations.

The PTX communication server 150 maintains separate translation queues for each target language to process incoming communications in an ordered manner, with timing control to ensure synchronized delivery across all language versions. When the PTT button 810 is released, the device sends a floor release indication, allowing other devices to receive but not transmit until the floor is granted to another device. This switching capability maintains synchronized reception while allowing users to dynamically change their preferred language for receiving group communications.

Embodiments described herein can be advantageously implemented to broadcast group communications in multiple languages in a group communications system. The system optimizes bandwidth utilization by selectively broadcasting only required language streams to specific broadcast areas based on actual user needs, implements flexible delivery mechanisms through either multi-TMGI or single-TMGI embodiments for efficient resource allocation, provides dynamic adaptation to changing language requirements as users move between areas, enables synchronized delivery of translated content across different languages through coordinated broadcast bearers and timing control, and offers an intuitive user interface for seamlessly switching between available translations while maintaining efficient resource utilization.

As should be apparent from this detailed description, the operations and functions of the computing devices described herein are sufficiently complex as to require their implementation on a computer system, and cannot be performed, as a practical matter, in the human mind. Electronic computing devices such as set forth herein are understood as requiring and providing speed and accuracy and complexity management that are not obtainable by human mental steps, in addition to the inherently digital nature of such operations (e.g., a human mind cannot interface directly with RAM or other digital storage, cannot transmit or receive electronic messages, electronically encoded video, electronically encoded audio, etc., among other features and functions set forth herein).

In the foregoing specification, specific embodiments have been described. However, one of ordinary skill in the art appreciates that various modifications and changes can be made without departing from the scope of the invention as set forth in the claims below. Accordingly, the specification and figures are to be regarded in an illustrative rather than a restrictive sense, and all such modifications are intended to be included within the scope of present teachings. The benefits, advantages, solutions to problems, and any element(s) that may cause any benefit, advantage, or solution to occur or become more pronounced are not to be construed as a critical, required, or essential features or elements of any or all the claims. The disclosure is defined solely by the appended claims including any amendments made during the pendency of this application and all equivalents of those claims as issued.

Moreover, in this document, relational terms such as first and second, top and bottom, and the like may be used solely to distinguish one entity or action from another entity or action without necessarily requiring or implying any actual such relationship or order between such entities or actions. The terms "comprises," "comprising," “has”, “having,” “includes”, “including,” “contains”, “containing” or any other variation thereof, are intended to cover a non-exclusive inclusion, such that a process, method, article, or apparatus that comprises, has, includes, contains a list of elements does not include only those elements but may include other elements not expressly listed or inherent to such process, method, article, or apparatus. An element preceded by “comprises …a”, “has …a”, “includes …a”, “contains …a” does not, without more constraints, preclude the existence of additional identical elements in the process, method, article, or apparatus that comprises, has, includes, contains the element. Unless the context of their usage unambiguously indicates otherwise, the articles “a,” “an,” and “the” should not be interpreted as meaning “one” or “only one.” Rather these articles should be interpreted as meaning “at least one” or “one or more.” Likewise, when the terms “the” or “said” are used to refer to a noun previously introduced by the indefinite article “a” or “an,” “the” and “said” mean “at least one” or “one or more” unless the usage unambiguously indicates otherwise.

Also, it should be understood that the illustrated components, unless explicitly described to the contrary, may be combined or divided into separate software, firmware, and/or hardware. For example, instead of being located within and performed by a single electronic processor, logic and processing described herein may be distributed among multiple electronic processors. Similarly, one or more memory modules and communication channels or networks may be used even if embodiments described or illustrated herein have a single such device or element. Also, regardless of how they are combined or divided, hardware and software components may be located on the same computing device or may be distributed among multiple different devices. Accordingly, in this description and in the claims, if an apparatus, method, or system is claimed, for example, as including a controller, control unit, electronic processor, computing device, logic element, module, memory module, communication channel or network, or other element configured in a certain manner, for example, to perform multiple functions, the claim or claim element should be interpreted as meaning one or more of such elements where any one of the one or more elements is configured as claimed, for example, to make any one or more of the recited multiple functions, such that the one or more elements, as a set, perform the multiple functions collectively.

It will be appreciated that some embodiments may be comprised of one or more generic or specialized processors (or “processing devices”) such as microprocessors, digital signal processors, customized processors and field programmable gate arrays (FPGAs) and unique stored program instructions (including both software and firmware) that control the one or more processors to implement, in conjunction with certain non-processor circuits, some, most, or all of the functions of the method and/or apparatus described herein. Alternatively, some or all functions could be implemented by a state machine that has no stored program instructions, or in one or more application specific integrated circuits (ASICs), in which each function or some combinations of certain of the functions are implemented as custom logic. Of course, a combination of the two approaches could be used.

Moreover, an embodiment can be implemented as a computer-readable storage medium having computer readable code stored thereon for programming a computer (e.g., comprising a processor) to perform a method as described and claimed herein. Any suitable computer-usable or computer readable medium may be utilized. Examples of such computer-readable storage mediums include, but are not limited to, a hard disk, a CD-ROM, an optical storage device, a magnetic storage device, a ROM (Read Only Memory), a PROM (Programmable Read Only Memory), an EPROM (Erasable Programmable Read Only Memory), an EEPROM (Electrically Erasable Programmable Read Only Memory) and a Flash memory. In the context of this document, a computer-usable or computer-readable medium may be any medium that can contain, store, communicate, propagate, or transport the program for use by or in connection with the instruction execution system, apparatus, or device.

Further, it is expected that one of ordinary skill, notwithstanding possibly significant effort and many design choices motivated by, for example, available time, current technology, and economic considerations, when guided by the concepts and principles disclosed herein will be readily capable of generating such software instructions and programs and ICs with minimal experimentation. For example, computer program code for carrying out operations of various example embodiments may be written in an object oriented programming language such as Java, Smalltalk, C++, Python, or the like. However, the computer program code for carrying out operations of various example embodiments may also be written in conventional procedural programming languages, such as the "C" programming language or similar programming languages. The program code may execute entirely on a computer, partly on the computer, as a stand-alone software package, partly on the computer and partly on a remote computer or server or entirely on the remote computer or server. In the latter scenario, the remote computer or server may be connected to the computer through a local area network (LAN) or a wide area network (WAN), or the connection may be made to an external computer (for example, through the Internet using an Internet Service Provider).

The terms “substantially”, “essentially”, “approximately”, “about” or any other version thereof, are defined as being close to as understood by one of ordinary skill in the art, and in one non-limiting embodiment the term is defined to be within 10%, in another embodiment within 5%, in another embodiment within 1% and in another embodiment within 0.5%. The term “one of”, without a more limiting modifier such as “only one of”, and when applied herein to two or more subsequently defined options such as “one of A and B” should be construed to mean an existence of any one of the options in the list alone (e.g., A alone or B alone) or any combination of two or more of the options in the list (e.g., A and B together).

A device or structure that is “configured” in a certain way is configured in at least that way, but may also be configured in ways that are not listed.

The terms “coupled”, “coupling” or “connected” as used herein can have several different meanings depending on the context in which these terms are used. For example, the terms coupled, coupling, or connected can have a mechanical or electrical connotation. For example, as used herein, the terms coupled, coupling, or connected can indicate that two elements or devices are directly connected to one another or connected to one another through an intermediate elements or devices via an electrical element, electrical signal or a mechanical element depending on the particular context.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separately claimed subject matter.

What is claimed is:

1. A method for broadcasting communications in multiple languages in a group communication system, the method comprising:
identifying, at a communication server, a plurality of communication devices affiliated with a communication group;
registering, at the communication server, a language preference for each of the communication devices in the plurality of communication devices affiliated with the communication group, wherein the language preference indicates a desired language for receiving group communications;
identifying, at the communication server, a first sub-group of communication devices currently located in a first broadcast area;
determining, at the communication server, a first set of languages to be used for broadcasting the group communications in the first broadcast area based on the language preferences of the sub-group of communication devices located in the first broadcast area; and
broadcasting, at the communication server, via one or more broadcast stations serving the first broadcast area, the group communications in the first set of languages to the first broadcast area.

2. The method of claim 1, further comprising:
refraining from broadcasting the group communications in any language other than the first set of languages to the first broadcast area.

3. The method of claim 1, further comprising:
identifying, at the communication server, a second sub-group of communication devices currently located in a second broadcast area;
determining, at the communication server, a second set of languages to be used for broadcasting the group communications in the second broadcast area based on the language preferences of the second sub-group of communication devices located in the second broadcast area; and
broadcasting, at the communication server, via one or more broadcast stations serving the second broadcast area, the group communications in the second set of languages to the second broadcast area.

4. The method of claim 3, further comprising:
refraining from broadcasting the group communications in any language other than the second set of languages to the second broadcast area.

5. The method of claim 3, wherein the second set of languages broadcasted to the second broadcast area includes at least one language that is different from the first set of languages broadcasted to the first broadcast area.

6. The method of claim 3, further comprising:
determining, that a particular communication device from the first sub-group of communication devices has moved from the first broadcast area to the second broadcast area;
determining that the second set of languages does not include a particular language indicated in the language preference registered at the communication server for the particular communication device;
updating the second set of languages to include the particular language; and
broadcasting, at the communication server, subsequent group communications intended for the communication group in the updated second set of languages to the second broadcast area.

7. The method of claim 1, further comprising:
sending, at the communication server, to each communication device included in the first sub-group of communication devices, control information identifying a respective broadcast channel to be used for receiving the group communications broadcasted in the first set of languages in the first broadcast area.

8. The method of claim 1, further comprising:
determining, at the communication server, that the language preferences of a first subset of communication devices in the first sub-group of communication devices indicate a common language preference corresponding to a first language included in the set of languages;
determining, at the communication server, that the language preferences of a second subset of communication devices in the first sub-group of communication devices indicate a common language preference corresponding to a second language included in the set of languages;
allocating a first broadcast channel for broadcasting the group communications in the first language and a second broadcast channel for broadcasting the group communications in the second language;
sending, at the communication server, to the first subset of communication devices, control information identifying a first channel identifier associated with the first broadcast channel; and
sending, at the communication server, to the second subset of communication devices, control information identifying a second channel identifier associated with the second broadcast channel.

9. The method of claim 8, wherein broadcasting comprises:
broadcasting, via the one or more broadcast stations serving the first broadcast area, the group communications in the first language over the first broadcast channel and the group communications in the second language over the second broadcast channel.

10. The method of claim 9, wherein the broadcast stations implement the first and second broadcast channels using at least one of: enhanced multimedia broadcast multicast services (eMBMS) in a 4G long term evolution (LTE) network; or media broadcast multicast service (MBS) in a 5G network.

11. The method of claim 9, further comprising:
determining whether the first and second languages are different from a source language used in an initial transmission of the group communications; and
prior to broadcasting the group communications in the first broadcast area, translating the group communications from the source language to the first language and the second language when the first and second languages are different from the source language.

12. The method of claim 8, further comprising:
configuring the first subset of communication devices to switch to the first broadcast channel using the first channel identifier to receive the group communications in the first language; and
configuring the second subset of communication devices to switch to the second broadcast channel using the second channel identifier to receive the group communications in the second language.

13. The method of claim 8, wherein the control information sent to at least one communication device in the first subset of communication devices further identifies the second channel identifier associated with the second broadcast channel with an indication that the second broadcast channel is used for broadcasting the group communications in the second language, the method further comprising:
enabling the at least one communication device in the first subset of communication devices to switch from the first broadcast channel to the second broadcast channel using the second channel identifier to receive the group communications in the second language.

14. The method of claim 1, further comprising:
determining, at the communication server, that the language preferences of a first subset of communication devices in the first sub-group of communication devices indicate a common language preference corresponding to a first language included in the set of languages;
determining, at the communication server, that the language preferences of a second subset of communication devices in the first sub-group of communication devices indicate a common language preference corresponding to a second language included in the set of languages;
allocating a single broadcast channel for broadcasting the group communications in the first language and the second language; and
sending, at the communication server, to the first and second subsets of the communication devices, control information including a channel identifier associated with the broadcast channel and a list of resource addresses each respectively identifying a resource from which the group communications in the first or second languages are to be retrieved.

15. The method of claim 14, wherein the list of resource addresses include internet protocol address, port numbers, or a combination thereof.

16. The method of claim 14, further comprising:
configuring the first subset of communication devices to switch to the single broadcast channel using the channel identifier and retrieve the group communications in the first language using the list of resource addresses; and
configuring the second subset of communication devices to switch to the single broadcast channel using the channel identifier and retrieve the group communications in the second language using the list of resource addresses.

17. A communication server comprising:
a memory configured to store language preference information for a plurality of communication devices affiliated with a communication group, the language preference indicating a desired language for receiving group communications; and
an electronic processor communicatively coupled to the memory, the electronic processor configured to:
identify a first sub-group of communication devices currently located in a first broadcast area;
determine a first set of languages to be used for broadcasting group communications in the first broadcast area based on the language preferences of the first sub-group of communication devices; and
broadcast the group communications in the first set of languages to the first broadcast area via one or more broadcast stations serving the first broadcast area.

18. The communication server of claim 17, wherein the electronic processor is further configured to:
determine that language preferences of a first subset of communication devices in the first sub-group of communication devices indicate a common language preference corresponding to a first language included in the set of languages;
determine that language preferences of a second subset of communication devices in the first sub-group of communication devices indicate a common language preference corresponding to a second language included in the set of languages;
allocate a first broadcast channel for broadcasting the group communications in the first language and a second broadcast channel for broadcasting the group communications in the second language; and
send control information to the first subset of communication devices, the control information identifying a first channel identifier associated with the first broadcast channel; and
send control information to the second subset of communication devices, the control information identifying a second channel identifier associated with the second broadcast channel.

19. The communication server of claim 18, wherein the electronic processor is configured to:
allocate separate temporary mobile group identifiers (TMGIs) for broadcasting the group communications in the first language and the second language respectively; or
allocate a single TMGI with different Internet Protocol (IP) address and port number combinations for broadcasting the group communications in the first language and the second language respectively.

20. The communication server of claim 18, wherein the electronic processor is configured to:
determine whether the first set of languages is different from a source language used in an initial transmission of the group communications; and
translate, prior to broadcasting the group communications, the group communications from the source language to each language in the first set of languages when the first set of languages is different from the source language.
